(19) United States
(12) Patent Application Publication
(10) Pub. No.: US 2013/0138770 A1
(43) Pub. Date: May 30, 2013

(54) APPARATUS AND METHOD FOR SHARING WEB CONTENTS USING INSPECTOR SCRIPT

(71) Applicants: Min-Jung KIM, Daejeon-si (KR); Moon-Soo LEE, Daejeon-si (KR); Sun-Joong KIM, Daejeon-si (KR); Kee-Seong CHO, Daejeon-si (KR)

(72) Inventors: Min-Jung KIM, Daejeon-si (KR); Moon-Soo LEE, Daejeon-si (KR); Sun-Joong KIM, Daejeon-si (KR); Kee-Seong CHO, Daejeon-si (KR)

(73) Assignee: ELECTRONICS AND TELECOMMUNICATIONS RESEARCH INSTITUTE, Daejeon-si (KR)

(21) Appl. No.: 13/548,322

(22) Filed: Jul. 13, 2012

(30) Foreign Application Priority Data
Nov. 29, 2011 (KR) 10-2011-0126285

(51) Int. Cl. G06F 15/16; G06F 17/00

(52) U.S. Cl. 709/217; 715/234

(57) ABSTRACT

An apparatus for sharing Web contents is provided. The apparatus includes a Web browser that loads and outputs a Web page, and a Web content transmission client that is linked with the Web browser to extract context information that is current state information from the Web page, and transmits the extracted context information to at least one other terminal.

### CROSS-REFERENCE TO RELATED APPLICATION

This application claims the benefit under 35 U.S.C. §119(a) of Korean Patent Application No. 10-2011-0126285, filed on Nov. 29, 2011, the entire disclosure of which is incorporated herein by reference for all purposes.

### BACKGROUND

1. Field

The following description relates to an apparatus and method for providing Web contents, and more particularly, to an apparatus and method for sharing Web contents by moving contents between a variety of devices such as personal computers (PCs), smart phones, tablets, televisions (TVs), and the like to thereby consistently provide services.

2. Description of the Related Art

Existing sharing of contents between devices has focused on sharing multimedia contents themselves between devices using digital living network alliance (DLNA) technology, cloud storage, or the like.

Meanwhile, a Web browser is loaded in all current devices including smart phones and televisions (TVs), and a variety of applications are loaded in the Web browser, and thereby functions of the Web browser are improved.

In addition, in order to provide Web services in various kinds of terminals through the Web browser, attempts are being made at sharing the same contents on a various screens.

When accessing a Web page through the Web browser, a Web page-related HTML document, cascading style sheet (CSS) information, and a Java Script code are downloaded to the browser.

The HTML document is loaded on the Web browser in the form of a document object model (DOM), and has a structure in which the DOM continuously changes even after the Web page is loaded by inserting the Javascript code into the Web page.

A core technique at the time of moving Web contents on the Web browser is to allow continuous provision of services even after moving the Web contents.

For this, a state after moving the Web contents is required to be restored to a state before moving the Web contents, by extracting an execution state before moving the contents.

A method of restoring a context may be classified as a server-side access method or a client-side access method.

The server-side access method is a technique in which state information is stored in the Web server itself, and context is restored when a user accesses the Web server.

The client-side access method is a technique in which context-related information is extracted by a client, the extracted information is transmitted to a reception side, and then Web contents are restored.

The server-side access method is required to set up a function in which state information for each user is stored in the Web server itself beginning when a Web site is designed, and the stored state information is restored at a time of reconnecting.

The client-side access method may be changed depending on data to be transmitted.

When a URL transmission method is simply used, such as in the conventional art, restoration with respect to a current execution state is impossible, and partial movement of Web contents is also impossible.

In addition, in a case of a specific site, a screen desired to be moved cannot be transmitted. That is, only when transmitting Web contents themselves (for example, images, text, or the like), may partial movement be possible, but later continuous provision of services cannot be ensured.

In addition, when a screen is shared through screen virtualization via a cloud, which is not a URL transmission method, a large amount of data composed of compressed images from a transmission side has to be transmitted without interruption, and therefore an amount of traffic increases in proportion to a number of terminals on a reception side.

### SUMMARY

The following description relates to an apparatus and method for sharing Web contents through inspector script insertion, whereby a currently executed state may be extracted through script code insertion on a transmission-side device and transmitted to a reception side to thereby enable continuous provision of services.

The following description relates to an apparatus and method for sharing Web contents whereby state information may be extracted by analyzing Web contents, and transmitted to a target device to restore the transmitted state information.

In one general aspect, there is provided an apparatus for sharing Web contents, including: a Web browser that loads and outputs a Web page; and a Web content transmission client that is linked with the Web browser to extract context information that is current state information from the Web page, and transmits the extracted context information to at least one other terminal.

In another general aspect, there is provided an apparatus for sharing Web contents, including: a Web browser that loads and outputs a Web page; and a Web content reception client that receives context information that is current state information of the Web page transmitted from another terminal, and is linked with the Web browser based on the received context information to restore and output the Web contents.

In still another general aspect, there is provided a method for sharing Web contents in a Web content transmission client, including: extracting context information associated with the Web contents loaded by a Web browser; and transmitting the extracted context information to a Web content reception client.

In yet another general aspect, there is provided a method for sharing Web contents in a Web content reception client, including: receiving context information from a Web content transmission client; analyzing the received context information to extract information required for context restoration; loading a Web page on a browser according to the extracted information; restoring context to a same state as before moving using the extracted context information; and displaying the restored context on a screen.

Other features and aspects will be apparent from the following detailed description, the drawings, and the claims.

### BRIEF DESCRIPTION OF THE DRAWINGS

FIG. 1 is a diagram illustrating a configuration example of a system for sharing Web contents to which the present invention is applied;

FIG. 2 is a detailed configuration diagram illustrating an apparatus for sharing Web contents according to a preferred embodiment of the present invention;

FIG. 3 is a diagram illustrating a method for sharing Web contents according to a preferred embodiment of the present invention;

FIG. 4 is a diagram illustrating context information extraction according to a preferred embodiment of the present invention;

FIG. 5 is a diagram illustrating context restoration according to a preferred embodiment of the present invention;

FIG. 6 is a diagram illustrating an example of context information extraction through inspector script insertion according to a preferred embodiment of the present invention; and

FIG. 7 is a diagram illustrating an example of DOM Tree restoration according to a preferred embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

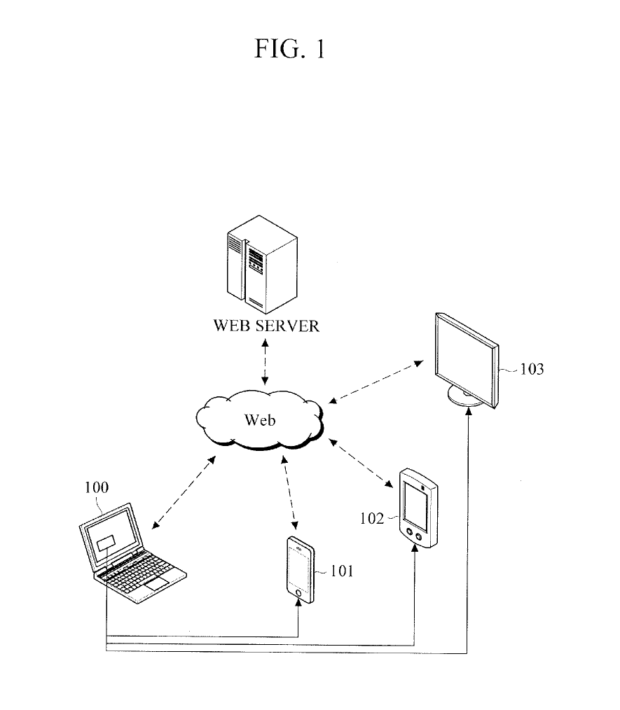

FIG. 1 is a diagram illustrating a configuration example of a system for sharing Web contents to which the present invention is applied.

Referring to FIG. 1, a system for Web content movement includes a Web content sharing device 100 (hereinafter, referred to as “terminal”) for transmitting Web contents, and a plurality of terminals 101, 102, and 103 for receiving Web contents. Each of the terminals 100, 101, 102, and 103 includes a screen on which the Web contents are to be displayed, and sizes thereof may differ.

The terminal 100 for transmitting the Web contents may transmit a part or all of Web contents currently expressed on a browser, as selected by a user.

Each of the terminals 101, 102, and 103 for receiving the Web contents analyzes the transmitted Web contents, and adjusts the analyzed Web contents according to a size of a corresponding screen to thereby display the adjusted Web contents.

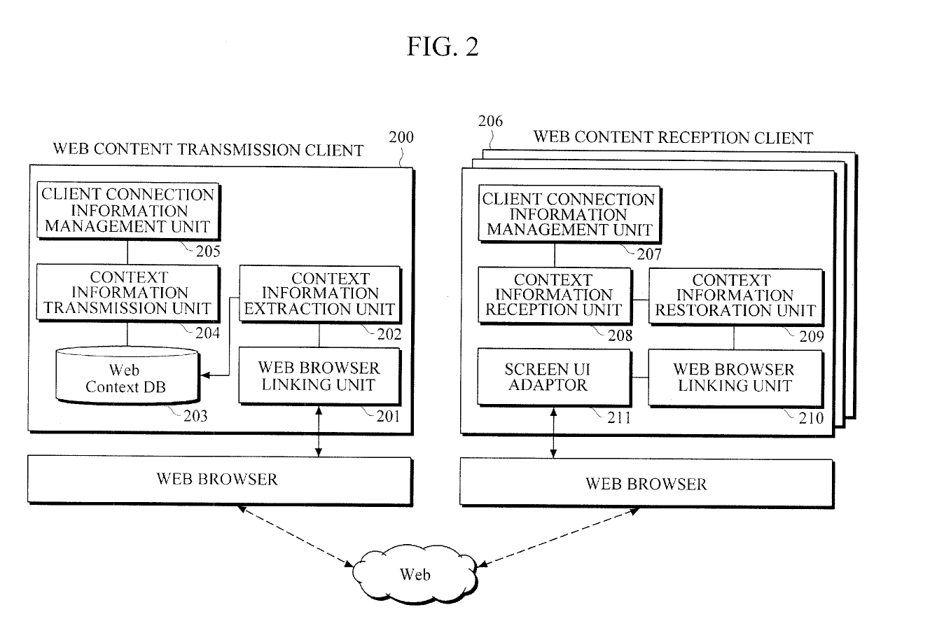

FIG. 2 is a detailed configuration diagram illustrating an apparatus for sharing Web contents according to a preferred embodiment of the present invention.

Referring to FIG. 2, the terminal 100 for transmitting the Web contents according to the present invention includes a Web content transmission client 200 which can be linked with a transmission-side Web browser.

Each of the terminals 101, 102, and 103 for receiving the Web contents includes a Web content reception client 206 which can be linked with a reception-side Web browser.

However, the Web content transmission client and the Web content reception client are loaded in the same terminal, so that both transmission and reception are performed.

The Web content transmission/reception clients may be loaded in the Web browser as extensions to thereby be linked with the Web browser, and may be configured such that related functions are added to functions of the browser itself.

In addition, the Web content transmission/reception clients may be configured in the form of their own application (WebApp or App) in such a manner as to be linked with a viewer function of the browser.

The Web content transmission client 200 includes a Web browser linking unit 201, a context information extraction unit 202, a context DB 203, a context information transmission unit 204, and a client connection information management unit 205.

The Web browser linking unit 201 is linked with the Web browser installed in the terminal to thereby process interaction with a user and enable Web page access.

The context information extraction unit 202 extracts current state information from a Web page output through the Web browser.

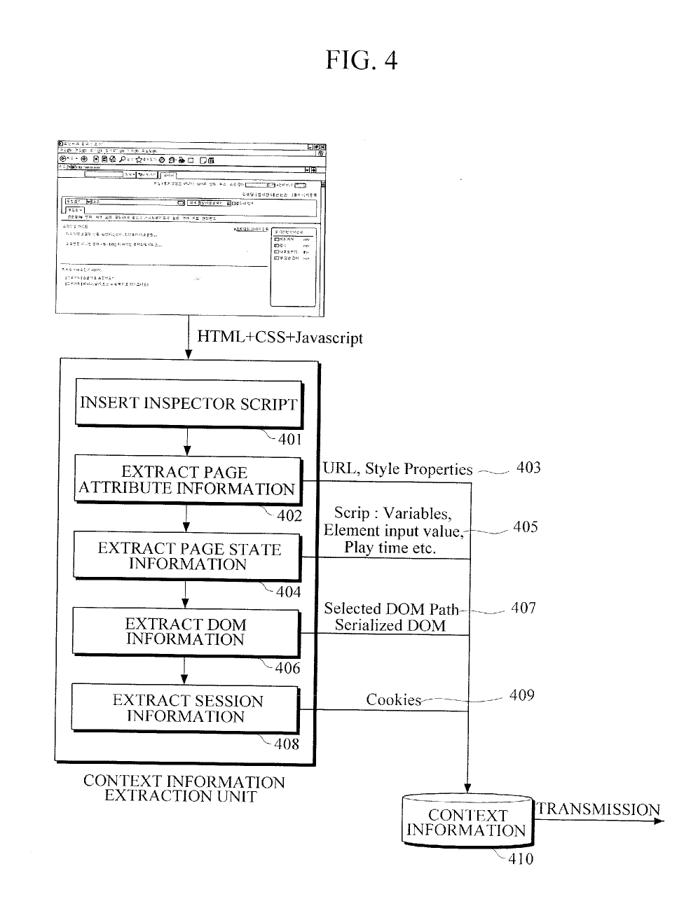

An operation of extracting the current state information by the context information extraction unit 202 will be described in detail with reference to FIG. 4.

The context DB 203 stores the current state information extracted from the Web page by the context information extraction unit 202.

The context information transmission unit 204 transmits the extracted information to the to Web content reception client 206 according to a format.

The transmission/reception clients may be connected by a relaying server or directly connected, but the present invention is not limited to a connection method between clients.

The client connection management unit 205 exchanges screen-related information while maintaining connection with the Web content reception client 206.

The Web content reception client 206 includes a client connection information management unit 207, a context information reception unit 208, a context information restoration unit 209, a screen UI adaptor 210, and a Web browser linking unit 211.

The client connection management unit 207 manages communication channel connection between clients.

The context information reception unit 208 receives related Web context information from the Web content transmission client 200.

The context information restoration unit 209 restores information of the Web contents based on the received context information.

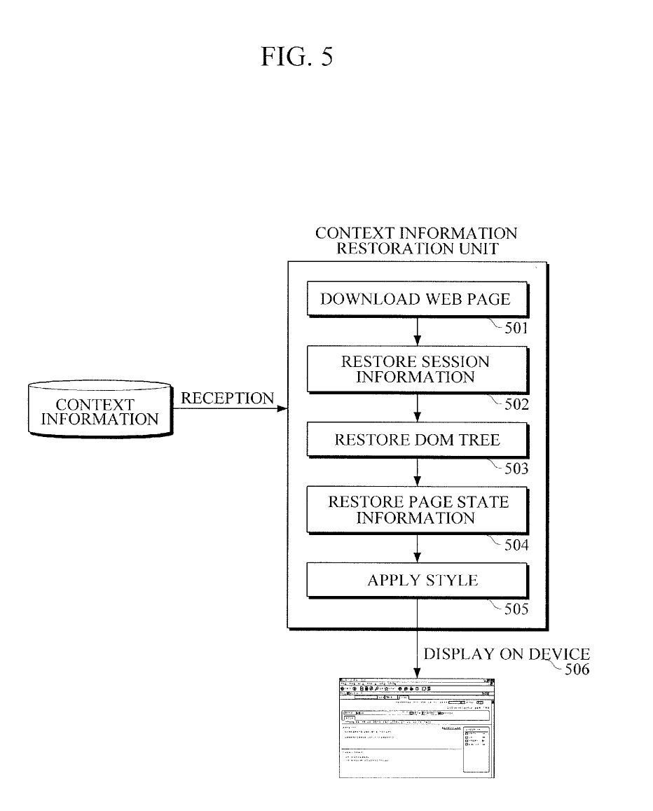

An operation of the context information restoration unit 209 will be described in detail with reference to FIG. 5.

The screen UI adaptor 210 generates and outputs the restored Web contents corresponding to a size of a screen of the terminal.

The Web browser linking unit 211 is linked with the Web browser loaded in the terminal, and outputs the Web contents on the screen.

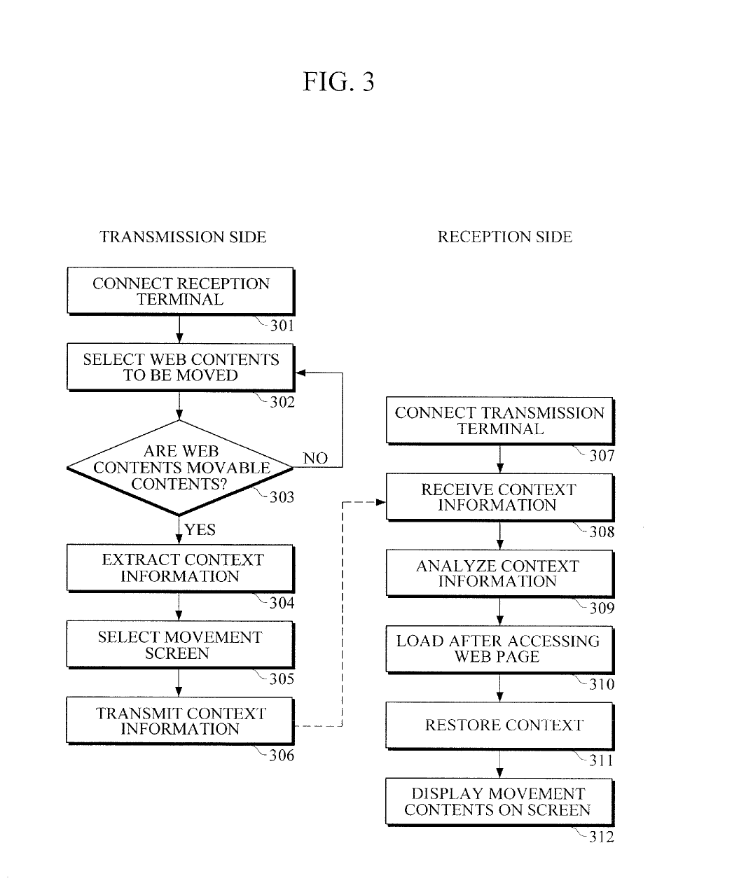

FIG. 3 is a diagram illustrating a method for sharing Web contents according to a preferred embodiment of the present invention.

Referring to FIG. 3, the method for sharing Web contents may include a transmission method performed by the Web content transmission client and a reception method performed by the Web content reception client.

First, the transmission method performed by the Web content transmission client will be described.

In operation 301, the Web content transmission client exchanges related information with the terminal receiving the Web contents and forms a communication channel.

In operation 302, the Web content transmission client, controlled by a user, selects Web contents to be moved. Here, the Web contents to be moved may be the whole Web page or a part of the Web page. In addition, the Web contents may include media within the Web page.

In operation 303, the Web content transmission client determines whether the Web contents selected by the user are movable contents.

In operation 304, when the Web contents are the movable contents based on the determination result of operation 303, the Web content transmission client extracts context information from the Web contents.

The extraction of the context information of operation 304 will be described in detail with reference to FIG. 4.

In operation 305, the Web content transmission client, controlled by the user, selects a reception terminal to which the Web contents are to be moved.

In operation 306, the Web content transmission client transmits, to the selected reception terminal, the context information extracted from the Web contents.

Next, the reception method performed by the Web content reception client will be described.

In operation 307, the Web content reception client forms a communication channel through information exchange with a transmission terminal.

In operation 308, the Web content reception client receives context from the Web content transmission client.

In operation 309, the Web content reception client analyzes the received context to extract information required for context restoration.

In operation 310, the Web content reception client accesses a corresponding URL among the analyzed information to thereby load a Web page on the browser.

In operation 311, when the loading of the Web page is completed, the Web content reception client restores the context to a same state as before moving using the context information.

The context restoration of operation 311 will be described in detail with reference to FIG. 5.

In operation 312, the Web content reception client generates and outputs the restored contents to correspond to a size of the screen.

FIG. 4 is a diagram illustrating context information extraction according to a preferred embodiment of the present invention.

When accessing a Web page through the Web browser, a Web page-related HTML document, cascading style sheet (CSS) information, and a Java Script code are downloaded to the Web browser.

The HTML document is loaded on the Web browser in the form of a document object model (DOM), and has a structure in which the DOM consistently changes even after the Web page is loaded by inserting the Javascript code into the Web page.

The context information extraction unit first stops the Javascript code currently executed, and starts to collect current state information.

In operation 401, the context information extraction unit identifies variables to be extracted in a Web page currently loaded, and inserts an inspector script code for extraction of the identified variables.

The context information extraction unit may enable access to a currently executed state using the inserted inspector script.

Thereafter, in operations 402 and 403, the context information extraction unit extracts attribute information such as a URL of the Web page currently accessed, applied style information, and the like.

In operations 404 and 405, the context information extraction unit extracts, as Web page state information, variables associated with execution of the Javascript and values previously input by a user to be submitted to a Web server. For example, point of time information of media currently executed or the like is extracted as the Web page state information.

In operations 406 and 407, the context information extraction unit extracts DOM information about a corresponding node as information about contents current selected, and path information within the Web page in which a DOM is currently positioned.

In operations 408 and 409, the context information extraction unit extracts session information that is connection information with the Web server for continuous performance of services even after moving Web contents, and transmits the extracted information to a reception terminal.

FIG. 5 is a diagram illustrating context restoration according to a preferred embodiment of the present invention.

In operation 501, Web page is accessed through received URL information, HTML, CSS, and a Javascript code of an initial state are loaded on a Web browser when the Web page is accessed, and extracted context information is transmitted to a reception side.

Thereafter, in operation 502, a context information restoration device analyzes the transmitted information to restore related session information. In this instance, when a re-login process is required in accordance with policy of a Web server, the context information restoration device permits a user to perform the re-login process. When a session is not separately required, this operation may be omitted.

In operation 503, the context information restoration device restores a DOM tree with respect to a selected node.

In operation 504, the context information restoration device restores variable information corresponding to a script execution state, user input information, and the like.

In operation 505, the context information restoration device applies a style to correspond to a screen to thereby display on the screen.

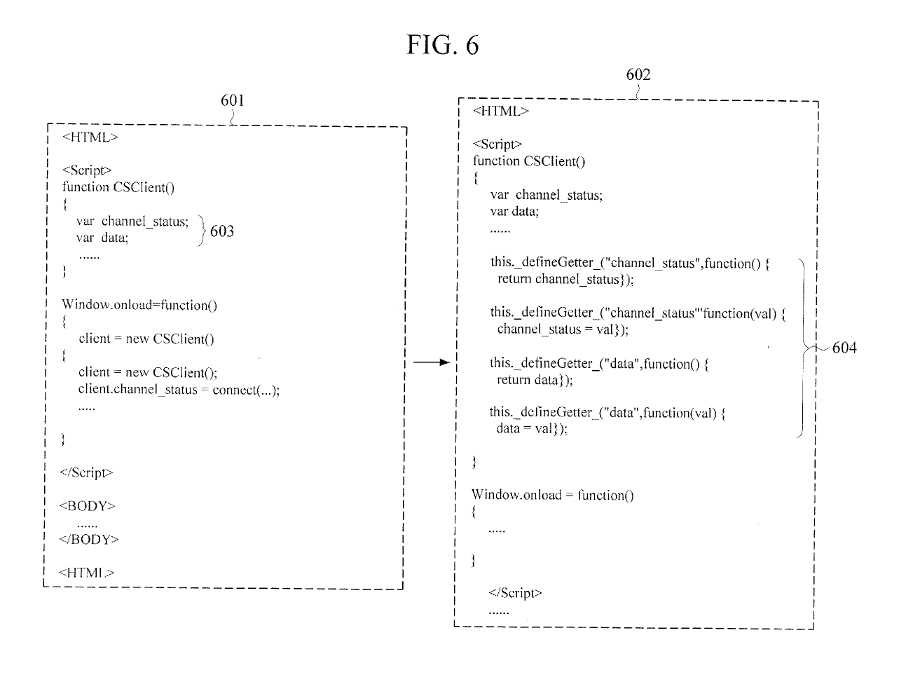

FIG. 6 is a diagram illustrating an example of context information extraction through inspector script insertion according to a preferred embodiment of the present invention.

According to the present invention, an inspector script is required to be inserted in the Javascript in order to extract an execution state of the Javascript which is loaded within an HTML document.

In a general method, the inspector script identifies objects in which access to a state of the object is impossible, and adds functions for access to state information of each of the objects.

A screen 601 indicates a code before the inspector script according to the present invention is inserted, and a screen 602 indicates a code after the inspector script is inserted.

An object identified by a code into which the inspector script is to be inserted is shown in a section 603, and a section 604 is obtained when the code is inserted into the section 603.

The context information extraction unit calls the inserted code to obtain a state value.

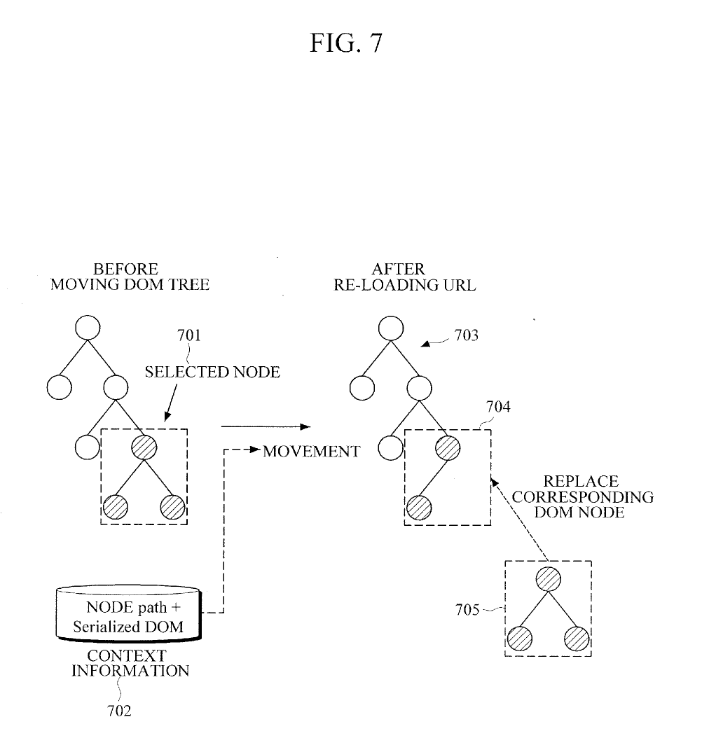

FIG. 7 is a diagram illustrating an example of DOM Tree restoration according to a preferred embodiment of the present invention.

In operation 701, when contents to be moved on a Web page are selected, information about a DOM node and the sub-nodes are extracted.

The DOM node may be periodically changed by the Javascript code inserted into the Web page, replaced through interaction with a user, and affected by a change in contents of the Web page.

Accordingly, in operation 702, path information of the selected node is moved together with DOM information.

When a URL is re-loaded in a reception side and a corresponding DOM is replaced in a node path position of a generated DOM tree, restoration of the DOM tree is completed.

As described above, according to the embodiments of the present invention, in order to move Web contents between screens, context information is extracted and transmitted together with a URL in a transmission side, and the context information is applied and used in restoration of the Web contents in a reception side, so that a state before moving the Web contents is maintained as is even after moving the Web contents.

In addition, context information is transmitted, and therefore an amount of data to be used when moving the Web contents is reduced compared to sharing a screen itself.

In addition, partial movement of the Web contents is possible for a device having a small screen size.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for sharing Web contents, comprising:
a Web browser that loads and outputs a Web page; and
a Web content transmission client that is linked with the Web browser to extract context information that is current state information from the Web page, and transmits the extracted context information to at least one other terminal.

2. The apparatus for sharing Web contents according to claim 1, wherein the Web content transmission client comprises:
a Web browser linking unit that is linked with the Web browser to enable Web page access;
a context information extraction unit that extracts the context information that is the current state information from the Web page; and
a context information transmission unit that transmits the extracted context information to a reception client according to a format.

3. The apparatus for sharing Web contents according to claim 2, wherein the Web browser linking unit processes interaction with a user.

4. The apparatus for sharing Web contents according to claim 2, wherein the Web content transmission client further includes a client connection management unit that exchanges screen-related information while maintaining connection with Web content reception clients.

5. An apparatus for sharing Web contents, comprising:
a Web browser that loads and outputs a Web page; and
a Web content reception client that receives context information that is current state information of the Web page transmitted from another terminal, and is linked with the Web browser based on the received context information to restore and output the Web contents.

6. The apparatus for sharing Web contents according to claim 5, wherein the Web content reception client comprises:
a context information reception unit that receives the context information from a Web content transmission client;
a context information restoration unit that restores information of the Web contents based on the received context information; and
a Web browser linking unit that is linked with the Web browser to express the Web contents.

7. The apparatus for sharing Web contents according to claim 6, wherein the Web content reception client further includes a client connection information management unit that manages communication channel connection with a Web content transmission client.

8. The apparatus for sharing Web contents according to claim 6, wherein the Web content reception client further includes a screen user interface adaptor that generates and outputs the restored Web contents according to a size of a screen of the apparatus.

9. A method for sharing Web contents in a Web content transmission client, comprising:
extracting context information associated with the Web contents loaded by a Web browser; and
transmitting the extracted context information to a Web content reception client.

10. The method for sharing Web contents according to claim 9, further comprising:
selecting the Web contents to be transmitted by a user.

11. The method for sharing Web contents according to claim 9, wherein the Web contents is a whole Web page loaded by the Web browser or a part of the Web page.

12. The method for sharing Web contents according to claim 9, further comprising:
determining whether the Web contents are movable contents.

13. The method for sharing Web contents according to claim 9, wherein the extracting comprises:
identifying variables to be extracted from a Web page currently loaded, and inserting an inspector script code for extraction into the identified variables;
extracting attribute information including a URL of a Web page currently accessed and applied style information;
extracting, as Web page state information, variables associated with execution of Javascript and values previously input by a user to be submitted to a Web server;
extracting DOM information about a corresponding node as information about contents current selected, and path information within the Web page in which a DOM is currently positioned; and
extracting session information that is connection information with the Web server for continuous performance of services even after moving the Web contents.

14. A method for sharing Web contents in a Web content reception client, comprising:
receiving context information from a Web content transmission client;
analyzing the received context information to extract information required for context restoration;
loading a Web page on a browser according to the extracted information;
restoring context to a same state as before moving using the extracted context information; and
displaying the restored context on a screen.

15. The method for sharing Web contents according to claim 14, wherein the restoring comprises:
accessing a Web page through URL information included in the received context information, and then restoring related session information;
restoring a DOM tree with respect to a selected node;
restoring variable information corresponding to a script execution state and user input information; and
applying a style corresponding to the screen to display on the screen.
